(19) United States
(12) Patent Application Publication
(10) Pub. No.: US 2007/0124073 A1
(43) Pub. Date: May 31, 2007

(54) OPERATION METHOD FOR NAVIGATOR

(75) Inventors: Ming-Jen Kuo, Taipei City (TW); Wan-Ling Cheng, Hualien County (TW); Liang-Ching Lin, Kaohsiung County (TW); Jien-Yang Chang, Taoyuan (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: MITAC INTERNATIONAL CORP., Taoyuan (TW)

(21) Appl. No.: 11/564,295

(22) Filed: Nov. 29, 2006

(30) Foreign Application Priority Data
Nov. 30, 2005 (TW) 94142020
Jan. 4, 2006 (TW) 095100382

(51) Int. Cl. G01C 21/00

(52) U.S. Cl. 701/213

(57) ABSTRACT

An operation method for a navigator is provided, the operation method comprising: determining whether a voice signal for playing in the navigator is received by the navigator, if yes, and the navigator is operated in a voice navigation mode, switching the navigator from the voice navigation mode to a reminder mode; and detecting whether the voice signal is stopped, if yes, the navigator is operated from the reminder mode to the voice navigation mode.

### CROSS-REFERENCE TO RELATED APPLICATION

This application claims the priority benefit of Taiwan application serial no. 94142020, filed Nov. 30, 2005 and Taiwan application serial no. 095100382, filed Jan. 4, 2006. All disclosure of the Taiwan application is incorporated herein by reference.

### BACKGROUND OF THE INVENTION

1. Field of Invention

The present invention relates to a navigator, more particularly, to an operation method for a navigator.

2. Description of Related Art

In recent years, with the development of human culture, science, and technology, important innovations have occurred in people's daily lives, for example, the development of the Global Positioning System (GPS). GPS is a navigation system using satellites and wireless technology for navigation and, precision measurement.

With the progress of science and technology, especially accurate positioning ability, GPS technology can be applied to current portable communication devices, such as cell phones and Personal Digital Assistants (PDAs) with built-in or external GPS antenna modules, for navigating and positioning vehicles, e.g., automobiles. Furthermore, the portable communication device also has various functions. For example, with the gradually increasing speed of computer operations and the rapid development of the Internet and wireless communication technology, the PDA has the functions of wireless communication, surfing on Internet, playing games, playing multimedia, etc. besides the functions of calendar and events, memorandum, address book, etc. Similarly, the cell phone also has the same advantages as the PDA, such as being light, small, and easy to carry. Thus, commercially available cell phones almost all have the same functions as PDAs. Furthermore, the portable communication device has become indispensable in modern life.

A PDA with a built-in or external GPS antenna module is commonly equipped in an automobile, and serves not only for voice navigation for driving but also various functions, such as, wireless communication, media playback, etc. Through the aforementioned functions, a user can not only play a medium and obtain a voice navigation message, but also communicate with others wirelessly when driving.

However, when the user is communicating with other people through the wireless communication device or playing the media, the voice navigation signal will interfere with a phone call signal or a voice signal. Additionally, the phone call signal, voice signal from the media playback, and voice navigation signal are usually generated through the same audio frequency or voice range and transmitted by the same trumpet or loudspeaker, such that it is more difficult to clearly distinguish the phone call signal, the voice from the media playback, and the voice navigation within the noisy circumstances of the automobile.

In some way, when receiving a phone call signal through the communication device, all of navigation modes will be forced to disable to prevent the interference of the phone call signal and the voice navigation signal. The disabled navigation modes will not be restarted until the phone call mode is finished. Such way to disable all of navigation modes will cause the navigation mode and communication mode fail to use at the same time. In addition, some waste time is required to restart the disabled navigation modes and is inconvenient for the user.

### SUMMARY OF THE INVENTION

Accordingly, the present invention is directed to provide an operation method for a navigator, so as to enable a user to clearly distinguish a received voice signal from a voice navigation signal.

The present invention is also directed to provide a switching method for a communication device for preventing interference between different signals having a same expression.

The present invention is still directed to provide a method for co-operating a plurality of navigation modes and a phone call mode for a communication device, such that the conventional disadvantages of restarting the navigation modes are avoided.

The present invention provides an operation method for a navigator, the operation method comprising: determining whether a voice signal for playing in the navigator is received by the navigator, if yes, and the navigator is operated in a voice navigation mode, switching the navigator from the voice navigation mode to a reminder mode; and detecting whether the voice signal is stopped, if yes, the navigator is operated from the reminder mode to the voice navigation mode.

According to one embodiment of the present invention, the voice signal includes MP3 music from media playback or phone call signal.

According to one embodiment of the present invention, the reminder mode includes one of a vibration mode accompanying a first warning tone or a vibration mode accompanying a second warning tone.

According to one embodiment of the present invention, the vibration mode accompanying the first warning tone indicates a first roadway information and the vibration mode accompanying the second warning tone indicates a second roadway information.

According to one embodiment of the present invention, the reminder mode includes a roadway information displayed on a screen, or displayed by a flash light.

According to one embodiment of the present invention, before the navigator is switched from the voice navigation mode to the reminder mode, a first piece of interval music is played for indicating that the voice navigation mode is to be switched to the reminder mode.

According to one embodiment of the present invention, the interval music may include one of a built-in ring tone, a piece of MP3 music, or a piece of music edited by a user.

According to one embodiment of the present invention, a second piece of interval music is playing before playing the voice signal by the navigator.

The present invention also provides a switching method for a communication device, a plurality of navigation modes being operated in the communication device, the switching method comprising: detecting a phone call signal; if the phone call signal being detected, receiving the phone call signal and switching at least one of the navigation modes into a reminder mode and activating a phone call mode for the communication device; and when the phone call mode is stopped, recovering the switched navigation mode from the reminder mode.

The present invention still provides a method for co-operating a plurality of navigation modes and a phone call mode for a communication device, the method comprising: detecting a phone call signal; if the phone call signal being detected, receiving the phone call signal and suspending at least one of the navigation modes and activating the phone call mode for the communication device and sending a phone call reminder; and recovering the suspended navigation mode to restart the suspended navigation mode, thereby the phone call mode and the plurality of navigation modes co-operate in the communication device.

Based on the above, the present invention provides an operation method and a switch method for a navigator to prevent interference between different signals having the same expression. In addition, the navigation modes and phone call mode can be co-operated, so that the user can perform the navigation mode and the phone call mode at the same time.

In order to achieve the aforementioned and other objects, features, and advantages of the present invention comprehensive, preferred embodiments will be described below in detail with reference to the accompanying drawings.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart of an operation method for a navigator according to a preferred embodiment of the present invention;

FIG. 2 is a flow chart of switching a voice navigation mode to a reminder mode according to a preferred embodiment of the present invention; and

FIG. 3 is a flow chart of transferring a voice navigation mode to a phone call mode or a media playback mode according to a preferred embodiment of the present invention.

FIG. 4 shows a method for co-operating navigation modes and a phone call mode according to another embodiment of the invention.

### DESCRIPTION OF EMBODIMENTS

Taking a multifunctional PDA phone as an example, it has the functions of media playback, voice navigation, wireless communication, and so on. One of the objects of the present invention is to provide an operation method for switching voice navigation mode to a reminder mode, so as to enable a user to clearly distinguish the voice navigation signal from the phone call signal, the voice signal from the media playback. The navigator of the present invention is mostly in the voice navigation mode. If the system is playing other voice signals, the switching of voice signals will be carried out as follows.

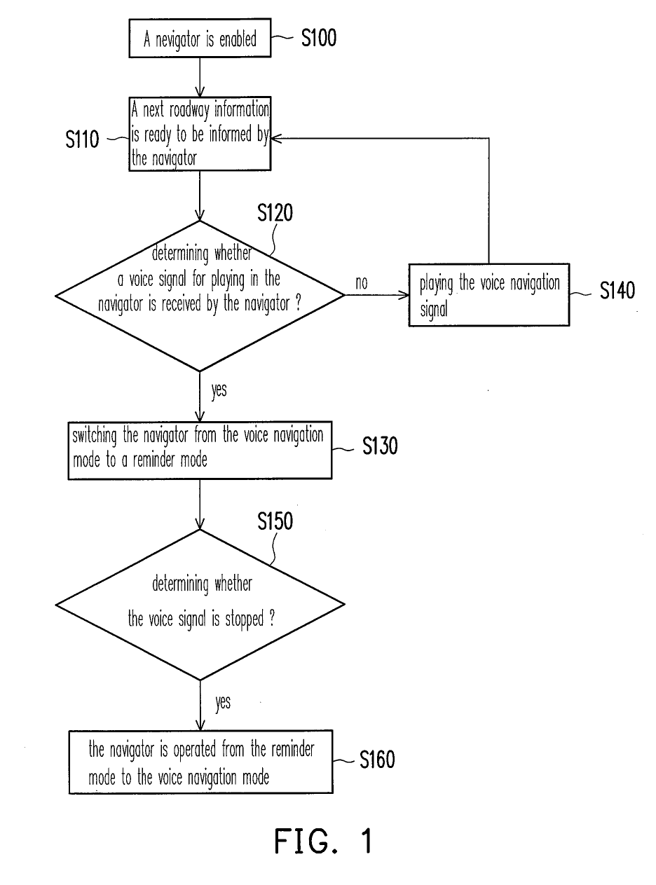

FIG. 1 is a flow chart of an operation method for switching voice navigation mode to a reminder mode according to a preferred embodiment of the present invention. Referring to FIG. 1, firstly, a navigator with a voice navigation mode is enabled to detect a roadway information in Step 100. Then, as shown in Step 110, a next roadway information is ready to be informed by the navigator. At this time, the flow goes to Step 120 to determine whether a voice signal for playing in the navigator is received by the navigator, if yes, the flow goes to Step 130 that the navigator switches from the voice navigation mode to a reminder mode. If the phone call signal or the voice signal is not yet received by the navigator, the flow goes to Step 140 that the voice navigation mode continues for playing a voice navigation signal. After Step 130, detecting whether the voice signal is stopped as shown in Step 150, if yes, then continues to Step 160 that the navigator is operated from the reminder mode to the voice navigation mode.

Herein, Step 150 is further described in detail. When the navigator has not stopped the phone call signal, the navigator will keep the reminder mode, and the flow will not enter Step 160 until the user stops the phone call signal or the voice signal from the media playback.

In the embodiment, the reminder mode indicates the roadway information by means of the vibration mode accompanying a warning tone. For example, when the user is in the first roadway circumstance, such as, turning left, the navigator will produce the vibration mode accompanying the first warning tone (a single “beep”) indicating the first roadway information. When the user is in the second roadway circumstance, such as, turning right, the navigator will produce the vibration mode accompanying the second warning tone (two “beeps”) indicating the second roadway information. Furthermore, the system may select important information, such as turning left, turning right, an exit, or an important crossing, etc., by means of the weight allocation of the voices and send other shrill warning tones to let the user pay more attention to the current roadway information.

As described above, the warning tone can be a voice message sent via a loudspeaker, or a sound effect message sent via a loudspeaker or a buzzer. The vibration mode can be generated by a vibrator built in the navigator, and multiple groups of vibration modes can be generated by setting the frequency of the vibrator, such as a sustained vibration for a suitable period or an intermittent vibration. Therefore, various options of the reminder mode are provided to the user through combining the diversified warning tones and multiple groups of vibration modes. Furthermore, the reminder mode can be achieved by displaying a roadway information on a screen or showing a roadway information by flashing signals. As for the reminder mode with the roadway information displayed on the screen, for example, directional labels are displayed on the screen, such as, a left arrow or a right arrow, wherein the distance between the current location and the destination is also displayed below the labels. As for the reminder mode with the roadway information being displayed by flashing signals, the flashing signals may come from one of two light emitting diodes (LED), e.g., used to indicate the progressing direction for the user.

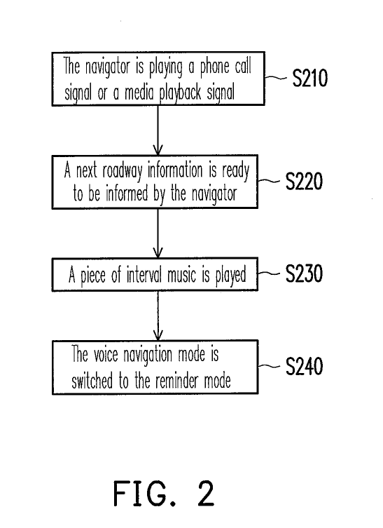

Additionally, besides switching the original voice navigation mode by the aforementioned warning tones and the vibration modes, in the step that the next roadway information is ready to be informed by the navigator, when the voice navigation mode is to be switched to the reminder mode, a piece of interval music can be played for informing the user that the navigator will be switched from the voice navigational content to the reminder mode. FIG. 2 is a flow chart of switching a voice navigation mode to a reminder mode according to a preferred embodiment of the present invention. Referring to FIG. 2, firstly, the navigator is playing the phone call signal or the media playback signal in Step 210. Then, as shown in Step 220, the next roadway information is ready to be informed by the navigator. Next, it goes to Step 230 that a piece of interval music is played to inform the user that the navigator will be switched from the voice navigational mode to the reminder mode. After Step 230, the flow goes to Step 240 that the voice navigational mode is switched to the reminder mode.

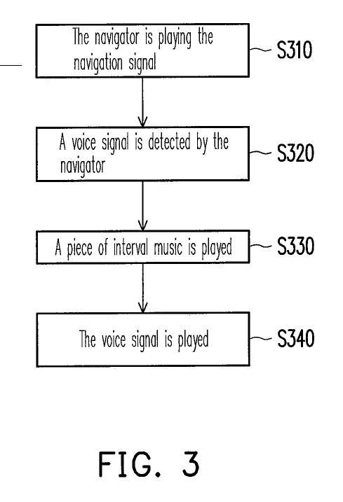

FIG. 3 is a flow chart of switching a voice navigation mode to a phone call mode or a media playback mode according to a preferred embodiment of the present invention. Referring to FIG. 3, firstly, the navigator is playing the voice navigation signal in Step 310. Then, as shown in Step 320, a voice signal is detected by the navigator, such as a phone call signal or a media playback signal. Next, it goes to Step 330 that a piece of interval music is played for transition. After Step S330, it goes to Step 340 that the voice signal is played. In this way, the user knows that the navigator will be switched from the voice navigation mode to the phone call mode or the media playback mode.

For example, the media playback signal can be the Mpeg Layer3 (MP3), the compact disc (CD), the radio broadcasting, and the like, and the users can enjoy the media playback signal in audio through the multifunctional medium player. The played interval music can be a sound effect of “clank . . . ”, a built-in ring tone, an MP3 music, a self-composed music, or a music downloaded from Internet, mainly used for enabling the user to easily know that the current state of the navigator is to be switched to the phone call mode or the media playback mode.

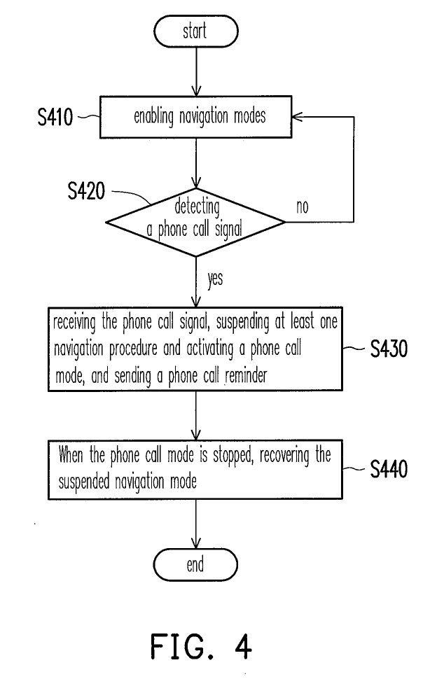

Now please refer to FIG. 4 which shows a method for co-operating navigation modes and a phone call mode for a communication device according to another embodiment of the invention. A plurality of navigation modes are enabled, as shown in Step S410. For example but not limited to, a voice navigation mode and an image navigation mode. These navigation modes may be performed concurrently and controlled by a predetermined priority order. Then, the navigator detects a phone call signal, as shown in Step S420. If the phone call signal is detected, the phone call signal is received and at least one of the navigation modes is suspended or switched to a reminder mode, and activating a phone call mode to send a phone call reminder, as shown in Step S430. Further, in Step S430, at least one navigation mode is maintained or not suspended. For example, either one of the voice navigation mode and the image navigation mode is suspended while the other one is maintained. The phone call reminder includes a ring mode, a vibration mode, or a phone call icon mode shown on a display screen of the navigator. Further, it is better that the navigation mode which has the same expression as the phone call reminder is to be suspended or switched. For example, in case of the phone call reminder being the ring mode, the voice navigation mode is suspended or switched, but the image navigation mode is maintained. With regard to how to switch the voice navigation mode to a reminder mode is shown in the above embodiments, wherein the voice navigation mode is switched into one of several different reminder modes, for preventing interference between the voice navigation mode and the phone call mode.

Then, when the phone call mode is stopped, recovering the suspended navigation mode or the switched navigation mode from the reminder mode, as shown in Step S440. Therefore, the phone call mode and a plurality of navigation modes co-operate in the communication device, such that the user may answer the incoming phone call without any interference.

In summary, the present invention provides a operation method for switching voice navigation mode to a reminder mode for preventing interference between different signals having the same expression. In addition, navigation modes and phone call mode are co-operated, so that the user can perform the navigation mode and the phone call mode at the same time.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An operation method for a navigator, the operation method comprising:
determining whether a voice signal for playing in the navigator is received by the navigator, if yes, and the navigator is operated in a voice navigation mode, switching the navigator from the voice navigation mode to a reminder mode; and
detecting whether the voice signal is stopped, if yes, the navigator is operated from the reminder mode to the voice navigation mode.

2. The method as claimed in claim 1, wherein the voice signal includes MP3 music or phone call signal.

3. The method as claimed in claim 1, wherein the reminder mode includes a first vibration mode accompanying a first warning tone or a second vibration mode accompanying a second warning tone.

4. The method as claimed in claim 3, wherein the first vibration mode accompanying the first warning tone indicates a first roadway information and the second vibration mode accompanying the second warning tone indicates a second roadway information.

5. The method as claimed in claim 1, wherein the reminder mode includes a roadway information displayed on a screen.

6. The method as claimed in claim 1, wherein the reminder mode includes a flashing signal to display a roadway information.

7. The method as claimed in claim 1, wherein before the navigator is switched from the voice navigation mode to the reminder mode, a first piece of interval music is played for indicating that the voice navigation mode is to be switched to the reminder mode.

8. The method as claimed in claim 7, wherein the interval music includes one of a built-in ring tone, a piece of MP3 music, and a piece of music edited by a user.

9. The method as claimed in claim 1, wherein a second piece of interval music is playing before playing the voice signal by the navigator.

10. A switching method for a communication device, a plurality of navigation modes being operated in the communication device, the switching method comprising:
detecting a phone call signal;
if the phone call signal being detected, receiving the phone call signal and switching at least one of the navigation modes into a reminder mode and activating a phone call mode for the communication device; and
when the phone call mode is stopped, recovering the switched navigation mode from the reminder mode.

11. The method as claimed in claim 10, wherein the reminder mode includes a vibration mode accompanying a first warning tone or a vibration mode accompanying a second warning tone.

12. The method as claimed in claim 11, wherein the first vibration mode accompanying the first warning tone indicates a first roadway information and the second vibration mode accompanying the second warning tone indicates a second roadway information.

13. The method as claimed in claim 10, wherein the reminder mode includes a roadway information displayed on a screen.

14. The method as claimed in claim 10, wherein the reminder mode includes a flashing signal displaying roadway information.

15. A method for co-operating a plurality of navigation modes and a phone call mode for a communication device, the method comprising:
detecting a phone call signal;
if the phone call signal being detected, receiving the phone call signal and suspending at least one of the navigation modes and activating the phone call mode for the communication device and sending a phone call reminder; and
recovering the suspended navigation mode to restart the suspended navigation mode, thereby the phone call mode and the plurality of navigation modes co-operate in the communication device.

16. The method as claimed in claim 15, wherein the step of suspending at least one navigation mode includes:
suspending one of the navigation modes; and
maintaining at least one of other navigation modes in an active state.

17. The method as claimed in claim 15, wherein if the expression of the phone call reminder is the same as one of the navigation modes, the navigation mode with the same expression is suspended or switched to a reminder mode.

18. The method as claimed in claim 15, wherein the plurality of navigation modes include a voice navigation mode and an image navigation mode.

19. The method as claimed in claim 15, wherein the phone call reminder includes at least one of an image mode, a ring mode and a vibration mode.
